(19) United States
(12) Patent Application Publication
(10) Pub. No.: US 2017/0097120 A1
(43) Pub. Date: Apr. 6, 2017

(54) PURIFYING CRYOGENIC FLUIDS

(71) Applicant: CooperSurgical, Inc., Trumbull, CT (US)

(72) Inventors: Patrick N. Gutelius, Monroe, CT (US); James R. Parys, Wallingford, CT (US)

(21) Appl. No.: 15/274,584

(22) Filed: Sep. 23, 2016

Related U.S. Application Data
(60) Provisional application No. 62/237,026, filed on Oct. 5, 2015.

(51) Int. Cl. F17C 9/02; F17C 3/04; B01D 29/90; F17C 13/04; F17C 13/06; F25B 19/00; F17C 3/12

(52) U.S. Cl. CPC F17C 9/02; F25B 19/005; F17C 3/04; F17C 3/12; F17C 13/04; F17C 13/06; B01D 29/90; F17C 2203/0629; F17C 2203/0639; F17C 2203/066; F17C 2203/0391; F17C 2221/014; F17C 2227/0107; B01D 2201/202

(57) ABSTRACT

A cryogenic fluid purification device comprising: a first container defining an interior region; a second container defining an interior region in fluid communication with the interior region of the first container; and a cryogenic fluid in contact with an exterior of the second container.

### CROSS-REFERENCE TO RELATED APPLICATION

This application claims priority to U.S. Provisional Patent Application No. 62/237,026, filed on Oct. 5, 2015, the entire contents of which is incorporated herein by reference.

### FIELD

This disclosure relates to devices and methods for purifying cryogenic fluids.

### BACKGROUND

Nitrogen, as an element of great technical importance, can be produced in a cryogenic nitrogen plant. Air inside a distillation column is separated at cryogenic temperatures (about 100K/−173° C.) to produce high purity nitrogen with 1 ppm of impurities. The process is based on the air separation, which was invented by Dr. Carl von Linde in 1895.

Liquid nitrogen is widely used in the pharmaceutical, biopharmaceutical, and life sciences industries for lyophilization and quick-freezing of pharmaceutical preparations and storage of cells and microbial cultures. However, liquid nitrogen can act as a vehicle for transmitting contaminants such as microorganisms.

Liquid nitrogen is a compact and readily transported source of nitrogen gas without pressurization. Further, its ability to maintain temperatures far below the freezing point of water makes it extremely useful in a wide range of applications, primarily as an open-cycle refrigerant.

### SUMMARY

The systems and methods described in this disclosure provide an approach to generating purified (ideally sterile) cryogenic fluid. These systems and methods can facilitate filtering liquid nitrogen in small volumes which can increase its affordability for many cryogenic preservation facilities (e.g., IVF facilities/labs)

Some cryogenic fluid purification devices include: a first container including a wall or walls with a heat transfer coefficient of between 0.01 W/(m·K) and 310 W/(m·K) (e.g., less than 100 W/(m·K), less than 50 W/(m·K), less than 25 W/(m·K), less than 10 W/(m·K), less than 5 W/(m·K), less than 1 W/(m·K), less than 0.5 W/(m·K), less than 0.25 W/(m·K), less than 0.2 W/(m·K)), the wall or walls defining an interior region of the first container; a second container defining a reservoir; and a filter disposed below the reservoir of the second container, wherein the filter provides fluid communication between the reservoir of the second container and the interior region of the first container. Embodiments of these devices can include one or more of the following features.

In some embodiments, an outer wall of the inner container and a corresponding inner wall of the outer container have the same shape with the outer wall of the inner container being slightly smaller. In some cases, engagement between the outer wall of the inner container and the corresponding inner wall of the outer container 110 provides a friction fit and seal which limits the flow of fluids out of the outer container between these walls.

In some embodiments, cryogenic fluid purification devices include a lid with a heat transfer coefficient of between 0.01 W/(m·K) and 20 W/(m·K) (e.g., less than 10 W/(m·K), less than 5 W/(m·K), less than 1 W/(m·K), less than 0.5 W/(m·K), less than 0.25 W/(m·K), less than 0.2 W/(m·K)). In some cases, the lid is configured to seal an opening in the inner container such that such that movement of gases out of the inner container other than through the filter are substantially prevented. In some cases, the lid comprises a pressure relief valve. In some cases, when the lid is attached to the first container, a spout of the first container provides the only pathway through thermal insulation provided by the outer container and the lid. In some cases, the lid includes a surface coating or arrangement of texture to inhibit the buildup of ice. In some cases, the lid includes a platinum and activated carbon element that inhibits condensation of oxygen.

Some cryogenic fluid purification devices include: a body having a heat transfer coefficient of between 0.01 W/(m·K) and 10 W/(m·K) (e.g., less than 5 W/(m·K), less than 1 W/(m·K), less than 0.5 W/(m·K), less than 0.25 W/(m·K), less than 0.2 W/(m·K)); a top portion removably attached to the body, the top portion having with a heat transfer coefficient of between 0.01 W/(m·K) and 10 W/(m·K) (e.g., less than 5 W/(m·K), less than 1 W/(m·K), less than 0.5 W/(m·K), less than 0.25 W/(m·K), less than 0.2 W/(m·K)); and a conduit with an inline filter.

In some embodiments, a top wall of the body defines at least one opening which allows fluid to pass between a reservoir defined by the body and a space defined between the body and the top portion when the top portion is attached to the body. In some cases, cryogenic fluid purification devices include a sealing mechanism operable to close the at least one opening. The sealing mechanism can be a plunge seal.

In some embodiments, cryogenic fluid purification devices include a heating element operable to accelerate the development of the vaporization pressure necessary to dispense a liquid cryogenic fluid from reservoir defined by the body. In some cases, the body comprises a section in which the insulation can be controllably removed and reset (e.g., wherein the section is hinged to the remainder of the body). In some cases, a control which operates both the heating element and a sealing mechanism operable to close the at least one opening simultaneously.

In some embodiments, the heating element comprises a heat transfer element that provides heat transfer into the liquid cryogen bath. In some cases, the heat transfer element has a first position in which a portion of the heating element is disposed in the reservoir and second position in which less of the heating element is disposed in the reservoir. In some cases, the heating element comprises an electric heater operable to heat fluid in the reservoir. In some cases, the electric heater includes a switch that is closed when a sealing mechanism operable to close the at least one opening is closed.

In some embodiments, the conduit extends from an inlet disposed in the reservoir near a bottom of the reservoir and extends through the top wall of the body to an outlet disposed in a dispensing spout.

In some embodiments, cryogenic fluid purification devices a pump operable to compress environmental air into the cryogenic fluid purification device. In some cases the top portion comprises a pressure relief valve to avoid over pressurization of the system.

In some embodiments, cryogenic fluid purification devices include a pump operable to compress fluid in a space defined between the body and the top portion when the top portion is attached to the body into a reservoir defined by the body.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIGS. 1A-1C show a cryogenic fluid purification device in use.

FIG. 2 shows a cryogenic fluid purification device.

FIG. 3 shows a cryogenic fluid purification device.

FIG. 4 shows a cryogenic fluid purification device.

FIG. 5 shows a cryogenic fluid purification device.

FIG. 6 shows a cryogenic fluid purification device.

Like reference symbols in the various drawings indicate like elements.

### DETAILED DESCRIPTION

The systems and methods described in this disclosure purify cryogenic fluids (e.g., liquid nitrogen) utilizing inexpensive filter technologies. These systems and methods include filling devices with supplied cryogenic fluid, containing the cryogenic fluid in a safe and insulated manner, processing the cryogenic fluid to remove impurities (e.g., filtering), and decanting the cryogenic fluid safely and in a controlled manner. Some devices are disposable while others are reusable.

Some systems use gravity and/or pressure to feed a liquid cryogen (e.g., liquid nitrogen) through a particulate filter for the purpose of purification. A clean (and possibly sterile) insulated container is fitted with a clean inner conduit (also possibly sterile) which forms a barrier and creates a space and reservoir. A clean (again possibly sterile) filtering member is placed in position below the reservoir so that the cryogenic fluid will enter the filter from the reservoir due to gravity.

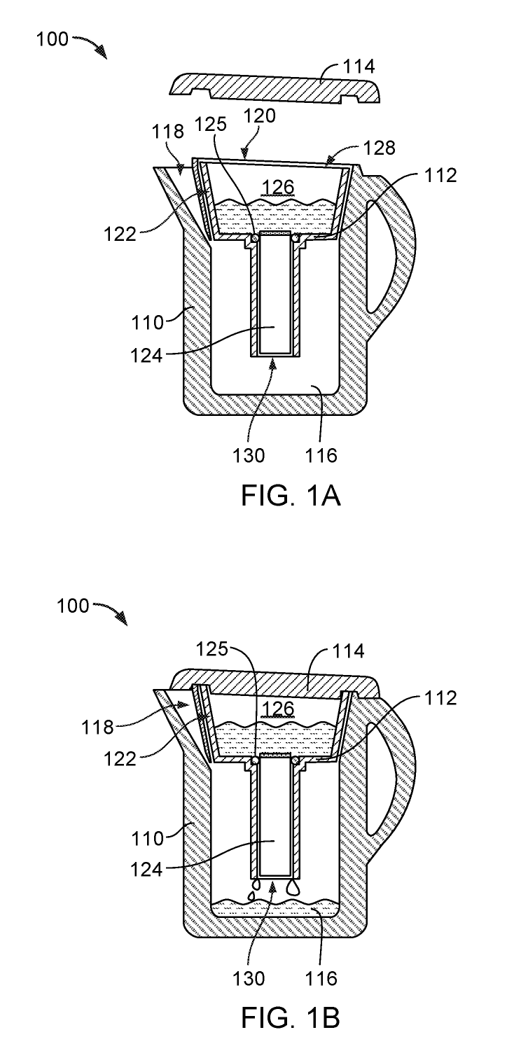

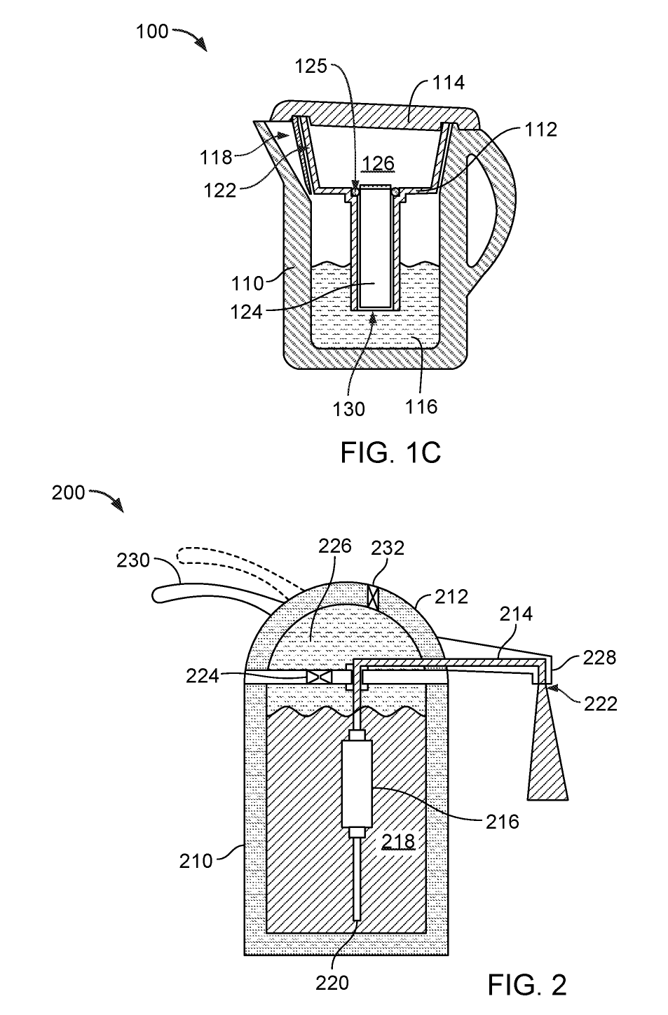

FIGS. 1A-1C show a cryogenic fluid purification device 100 that includes a first or outer container 110, a second or inner container 112, and a lid 114. The outer container 110 defines an inner chamber 116 as well as a spout 118 and an opening 120 which extend through the walls of the outer container 110. The inner chamber 116 and the opening 120 of the outer container are sized and configured to receive the inner container 112. The outer container has a steel or polymer shell filled with a vacuum or insulative material which reduces heat transfer through the outer container 110. The aggregate heat transfer coefficient of the container 110 would ideally be between 0.01 W/(m·K) and 0.20 W/(m·K).

The inner container 112 has an upper portion 122 and a filter 124. In the cryogenic fluid purification device 100, the upper portion 122 and the filter 124 are separate components with the filter 124 inserted through an opening in the bottom of the upper portion 122. A gasket material 125 provides a seal between the upper portion 122 and the filter 124 that limits the flow of fluids through the interface between the upper portion 122 and the filter 124. This configuration facilitates replacement of the filter. Some devices use inner containers in which the upper portion 122 and the filter 124 are a single integrated component.

The upper portion 122 of the inner container 112 is above the filter as shown in the FIGS. 1A-1C when the cryogenic fluid purification device 100 is being used. The upper portion 122 defines a reservoir chamber 126 in fluid communication with the filter 124. The reservoir 126 has an inlet 128 through which fluid to be purified is introduced into the reservoir 126 and the filter 124 has an outlet 130 through which purified fluid is discharged from the filter 124 into the outer container 110.

In the cryogenic fluid purification device 100, the outer wall of the upper portion 122 of the inner container 112 and the corresponding inner wall of the outer container 110 have the same shape with the outer wall of the upper portion 122 of the inner container 112 being slightly smaller. When the inner container 112 is inserted into the outer container 110, the outer wall of the upper portion 122 of the inner container 112 engages the corresponding inner wall of the outer container 110. In some devices, this engagement provides a friction fit and seal which limits the flow of liquids and/or gases out of the outer container 110 between these walls.

The outer wall of the upper portion 122 of the inner container 112 and the inner wall of the outer container 110 extend slightly above the surrounding portions of the outer container 110. This extension provides a rim that engages a corresponding groove on the lid 114. In the cryogenic fluid purification device 100, a laterally extending ridge on the extension engages a detent on the lid 114 to provide a snap-lock engagement between the extension and the lid. A gasket material within the groove provides a seal between the lid 114 and the extension which limits the flow of liquids and/or gases out of the outer container 110 between the lid 114 and the extension. This seal limits the escape of vapor phase cryogenic fluid. As the liquid cryogenic fluid vaporizes, the pressure in the inner container 112 increases and provides an additional force driving the liquid phase cryogenic fluid out of the inner container 112 through the filter 124. In some devices, the lid 114 includes a pressure relief valve that limits pressure buildup due evaporation of the liquid cryogen in the inner container.

Like the outer container 110, the lid 114 has a steel or polymer shell filled with a vacuum or insulative material which reduces heat transfer through the lid 114. When the lid 114 is attached to the other components of the cryogenic fluid purification device 100, the spout 118 provides the only pathway through the thermal insulation provided by the outer container 110 and the lid 114. This configuration limits the heat transfer associated with components such as, for example, pump inlets that extend through the walls of some other cryogenic fluid storage and/or purification devices. Lowering the heat transfer can slow the rate of evaporation of the liquid cryogenic fluid. Some devices include a closure mechanism such as, for example, a plug, a cap, or a valve limiting the escape of vapor phase cryogenic fluid through the spout.

In some devices, the lid 114 is a surface coating or arrangement of texture to inhibit the buildup of ice. In some devices, the lid 114 is configured to seal out atmospheric gases from chamber 126 which inhibits the condensation of undesirable elements such as, for example, oxygen in the device, but permits the escape of vaporized gas from the chamber via a limiting valve feature.

In use, the cryogenic fluid purification device 100 is assembled by inserting the inner container 112 into the outer container 110 until the inner container 112 is firmly seated. The cryogenic fluid (e.g., liquid nitrogen) to be purified is poured or otherwise transferred into the reservoir 126 is shown in FIG. 1A. As shown in FIG. 1B, gravity pulls the cryogenic fluid in the reservoir 126 through the filter 124 into the inner chamber 116 of the outer container 110. As discussed above, the vaporization pressure generated by the evaporation of the cryogenic fluid in the upper portion 122 of the inner container 112 can provide an additional force driving the liquid phase cryogenic fluid out of the inner container 112 through the filter 124. FIG. 1C shows the system after most of the cryogenic fluid has passed through the filter 124 into the inner chamber of the outer container 110. A user can then decant the cryogenic fluid through the spout 118 into working vessels.

Some cryogenic fluid purification devices use gas pressure to cause the cryogenic fluid (e.g., liquid nitrogen) to flow from a reservoir to an outlet through a conduit that includes a filter.

FIG. 2 shows a cryogenic fluid purification device 200 that includes a body 210, a top portion 212, and a conduit 214 with a filter 216 inline. The top portion 212 is removably attached to the body 210. Both the body 210 and the top portion 212 are insulated to limit thermal transfer through these components of the cryogenic fluid purification device 200. The top wall of the body 210 defines opening(s) 224 which allow(s) fluid to pass between a reservoir 218 defined by the body 210 and a space 226 defined between the body 210 and the top portion 212 when the top portion 212 is attached to the body 210. The fluid can be, for example, liquid cryogen being introduced into the reservoir 218 or gas moving between the space 226 and the reservoir 218.

The conduit 214 extends from an inlet 220 disposed in the reservoir 218 to an outlet 222. The conduit 214 is positioned with its inlet 220 near the bottom of the reservoir 218 and extends through the top wall of the body 210 to a dispensing spout 228 which houses the outlet 222. In the cryogenic fluid purification device 200, the filter 216 is an integrated in-line filter. The filter may be above, partially submerged in, or fully submerged in the liquid cryogen depending on the level of the liquid cryogen in the reservoir 218. Systems configured to keep the filter in a position where it stays at sub-zero temperatures can limit liquid water ingress. In some systems, the conduit 214 and the filter 216 are removable.

The top portion 212 includes a pump 230 operable to compress environmental air into the cryogenic fluid purification device 200. In the cryogenic fluid purification device 200, the pump is a positive displacement pump operated by pushing the handle of the pump 230 downward. Some devices use other pressurizing mechanisms such as, for example, bellows or diaphragm systems. An increase in pressure in the reservoir 218 induces flow of the cryogenic liquid through the conduit 214. The top portion 212 includes a pressure relief valve 232 to avoid over pressurization of the system.

In some devices, the pump 230 uses a retained portion of evaporated cryogenic fluid rather environmental air as the pressurizing fluid. This avoids introducing oxygen into the system with the environmental air. For example, liquid nitrogen in reservoir boiling off due to natural heat transfer can be at least partially collected in the space 226. Operation of the pump 230 pressurizes the nitrogen gas in the space 226 back into reservoir 218 thus inducing flow of the liquid nitrogen through the conduit 214. These devices may include controls such as, for example, check valves or pressure relief valves between the space 226 and the reservoir 218 to selectively isolate the space 226 and the reservoir 218 from each other.

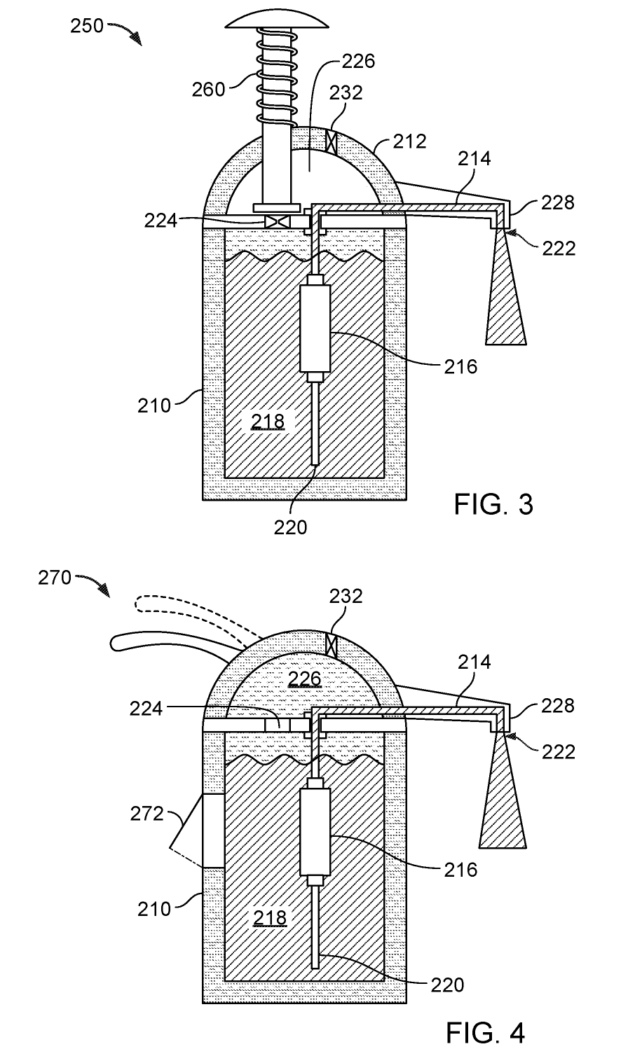

FIG. 3 shows a cryogenic fluid purification device 250 that is substantially similar to the cryogenic fluid purification device 250. However, the cryogenic fluid purification device 250 pressurizes the reservoir 218 by simply sealing the reservoir 218 except for the conduit 214. This allows vaporization pressure to build-up due to gradual, and natural, heat transfer from ambient conditions around the cryogenic fluid purification device 250. Once adequate pressure is reached, the cryogenic fluid is biased to flow from the reservoir 218, through the filter 216, and out the outlet 222.

The cryogenic fluid purification device 250 includes sealing mechanism 260 operable to close the opening 224 in the upper wall of the body 210. In cryogenic fluid purification device 250, the sealing mechanism 260 is a plunge seal but other cryogenic fluid purification devices use other sealing mechanisms such as, for example, rotary valves. The opening 224 is left unobstructed until a user wants to dispense purified cryogenic fluid. The sealing mechanism 260 is then operated to close the opening 224. When not dispensing, the evaporation pressure of the liquid cryogenic fluid is released through opening 224 and then through pressure relief valve 232.

FIGS. 4-6 show cryogenic fluid purification devices that are generally similar to the devices described above but that include heating elements to accelerate the development of the vaporization pressure necessary to dispense the liquid cryogenic fluid.

FIG. 4 shows a cryogenic fluid purification device 270 that is similar to the cryogenic fluid purification device 200 with an additional feature which increases the heat transfer rate. The cryogenic fluid purification device 270 includes a section 272 in which the insulation can be controllably removed and reset. In the illustrated device, the section 272 is hinged to expose a portion of the inner wall of the body 210. In other devices, the section can slide or be extracted be to expose a portion of the inner wall of the body 210.

As the heat transfer rate increases, the evaporation rate of the cryogenic fluid also increases. If this feature was synchronized to a sealing mechanism (e.g., the sealing mechanism 260 shown in cryogenic fluid purification device 250) so that there was single path through the spout, the increasing rate and magnitude of vaporization pressure can cause faster, higher volume flows. When the seal was released, venting the vapor pressure build-up, the fluid flowing through the spout would stop. When the insulation is replaced, the rate of heat transfer will decrease reducing the volume of nitrogen boiling off and lost to atmospheric venting.

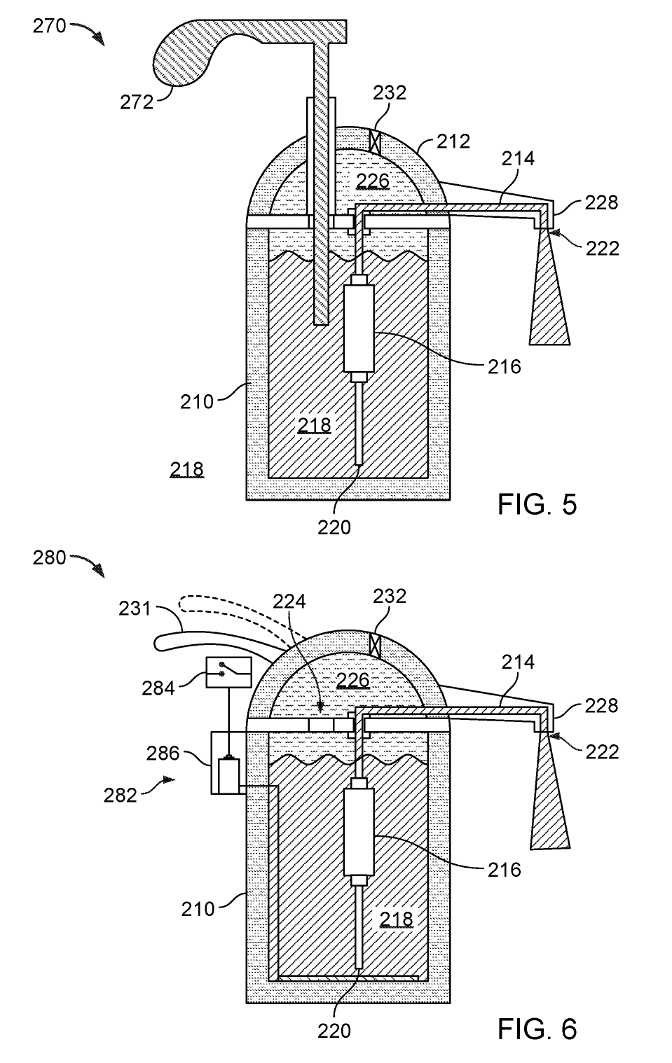

FIG. 5 shows a cryogenic fluid purification device 270 with an element that provides heat transfer into the liquid cryogen bath. The cryogenic fluid purification device 270 includes a heat transfer element 274 that can be inserted directly into the liquid cryogenic fluid after or during sealing of the reservoir 218. The flow of the cryogenic liquid can be arrested by releasing the seal (not shown). The rate of heat transferred to the liquid nitrogen can be reduced by drawing the heat-sink out from the reservoir 218 of cryogenic fluid.

FIG. 6 also shows a cryogenic fluid purification device 280 with an element that provides heat transfer into the liquid cryogen bath. The cryogenic fluid purification device 280 includes an electric heater 282 operable to heat fluid in the reservoir 218. The electric heater includes a switch 284 that is closed when the seal or valve over opening 224 is closed by depressing the handle 231. Closing the switch 284 completes a circuit and conduct energy from a power source 286 to a heating element 288 placed in the liquid nitrogen chamber thereby increasing the evaporation rate. Releasing the handle 231 vents the reservoir 218 and opens the switch 284.

A number of embodiments of the invention have been described. Nevertheless, it will be understood that various modifications may be made without departing from the spirit and scope of the invention. Accordingly, other embodiments are within the scope of the following claims.

What is claimed is:

1. A cryogenic fluid purification device comprising:
a first container including a wall or walls with a heat transfer coefficient of between 0.01 W/(m·K) and 10 W/(m·K), the wall or walls defining an interior region of the first container;
a second container defining a reservoir; and
a filter disposed below the reservoir of the second container, wherein the filter provides fluid communication between the reservoir of the second container and the interior region of the first container.

2. The cryogenic fluid purification device of claim 1, wherein an outer wall of the inner container and a corresponding inner wall of the outer container have the same shape with the outer wall of the inner container being slightly smaller.

3. The cryogenic fluid purification device of claim 2, wherein engagement between the outer wall of the inner container and the corresponding inner wall of the outer container 110 provides a friction fit and seal which limits the flow of fluids out of the outer container between these walls.

4. The cryogenic fluid purification device of claim 1, comprising a lid with a heat transfer coefficient of between 0.01 W/(m·K) and 10 W/(m·K).

5. The cryogenic fluid purification device of claim 4, wherein the lid is configured to seal an opening in the inner container such that such that movement of gases out of the inner container other than through the filter are substantially prevented.

6. The cryogenic fluid purification device of claim 5, wherein the lid comprises a pressure relief valve.

7. The cryogenic fluid purification device of claim 5, wherein, when the lid is attached to the first container, a spout of the first container provides the only pathway through thermal insulation provided by the outer container and the lid.

8. The cryogenic fluid purification device of claim 5, wherein the lid comprises a surface coating or arrangement of texture to inhibit the buildup of ice.

9. The cryogenic fluid purification device of claim 5, wherein the lid comprises a platinum and activated carbon element that inhibits condensation of oxygen.

10. A cryogenic fluid purification device comprising:
a body having a heat transfer coefficient of between 0.01 W/(m·K) and 10 W/(m·K);
a top portion removably attached to the body, the top portion having with a heat transfer coefficient of between 0.01 W/(m·K) and 10 W/(m·K); and
a conduit with an inline filter.

11. The cryogenic fluid purification device of claim 10, wherein a top wall of the body defines at least one opening which allows fluid to pass between a reservoir defined by the body and a space defined between the body and the top portion when the top portion is attached to the body.

12. The cryogenic fluid purification device of claim 11, comprising a sealing mechanism operable to close the at least one opening.

13. The cryogenic fluid purification device of claim 12, wherein the sealing mechanism is a plunge seal.

14. The cryogenic fluid purification device of claim 11, comprising a heating element operable to accelerate the development of the vaporization pressure necessary to dispense a liquid cryogenic fluid from reservoir defined by the body.

15. The cryogenic fluid purification device of claim 14, wherein the body comprises a section in which the insulation can be controllably removed and reset.

16. The cryogenic fluid purification device of claim 15, wherein the section is hinged to the remainder of the body.

17. The cryogenic fluid purification device of claim 14, wherein a control which operates both the heating element and a sealing mechanism operable to close the at least one opening.

18. The cryogenic fluid purification device of claim 14, wherein the heating element comprises a heat transfer element that provides heat transfer into the liquid cryogen bath.

19. The cryogenic fluid purification device of claim 18, wherein the heat transfer element has a first position in which a portion of the heating element is disposed in the reservoir and second position in which less of the heating element is disposed in the reservoir.

20. The cryogenic fluid purification device of claim 14, wherein the heating element comprises an electric heater operable to heat fluid in the reservoir.

21. The cryogenic fluid purification device of claim 20, wherein the electric heater includes a switch that is closed when a sealing mechanism operable to close the at least one opening is closed.

22. The cryogenic fluid purification device of claim 10, wherein the conduit extends from an inlet disposed in the reservoir near a bottom of the reservoir and extends through the top wall of the body to an outlet disposed in a dispensing spout.

23. The cryogenic fluid purification device of claim 10, comprising a pump operable to compress environmental air into the cryogenic fluid purification device.

24. The cryogenic fluid purification device of claim 23, wherein the top portion comprises a pressure relief valve to avoid over pressurization of the system.

25. The cryogenic fluid purification device of claim 10, comprising a pump operable to compress fluid in a space defined between the body and the top portion when the top portion is attached to the body into a reservoir defined by the body.
